(19) United States
(12) Patent Application Publication
(10) Pub. No.: US 2025/0320995 A1
(43) Pub. Date: Oct. 16, 2025

(54) PURSE WITH ADJUSTABLE LIGHTED INTERIOR

(71) Applicant: Kenneth W. Thompwon, Washington, DC (US)

(72) Inventor: Kenneth W. Thompwon, Washington, DC (US)

(21) Appl. No.: 19/177,178

(22) Filed: Apr. 11, 2025

Related U.S. Application Data
(60) Provisional application No. 63/632,576, filed on Apr. 11, 2024.

(51) Int. Cl. F21V 33/00; A45C 1/02; A45C 3/06; A45C 11/00; A45C 15/06; A45F 3/00; A45F 3/02; F21V 23/04; F21Y 113/10

(52) U.S. Cl. CPC F21V 33/0008; A45C 1/02; A45C 3/06; A45C 11/008; A45C 15/06; A45F 3/02; F21V 23/0471; A45F 2003/003; F21Y 2113/10

(57) ABSTRACT

A lighted bag liner added to an existing purse/bag OR built within the interior (bottom and/or sides) of a new purse. It is on a mesh-netting. When illuminated (i.e., turned on by a switch or phone app), it will help its user see the contents of their purse/bag.

### CROSS-REFERENCE TO RELATED APPLICATIONS

This is a perfection of the provisional application Ser. No. 63/632,576, filed on Apr. 11, 2024, the disclosure of which is fully incorporated herein.

### STATEMENT REGARDING SPONSORED FEDERALLY RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

### Not Applicable.

### STATEMENT REGARDING PRIOR DISCLOSURES BY THE INVENTOR OR A JOINT INVENTOR

Not Applicable.

### BACKGROUND OF THE INVENTION

(1) Field of the Invention. This invention relates generally to a device for illuminating the interior of a portable receptacle such as a purse.

A purse is often considered an important fashion accessory. Most purses are designed to keep up with the latest trends and to conveniently and effectively carry many items comfortably. A purse can be impossible to view the contents in a dark location or when multiple items exist inside. A conventional purse (also applies to handbags, makeup bags, some wallets, etc.) does not have any interior lighting to easily find items. Accordingly, there is a need for a purse with lighting that allows the purse contents to be seen.

The present invention generally relates to illumination devices for use in a purse. It is also adaptable for use in a clutch, tote, handbag, backpack, shoulder bag, attaché, makeup bag, shoulder bag and/or some small luggage items. This invention allows a user to easily activate and sufficiently illuminate the bag interior.

### (2) Description of Related Art Including Information Disclosed Under 37 CFR 1.97 and 1.98

U.S. Published Application No. 2009/019602 A1 issued to O'Neil uses a different light source and different attachment method.

U.S. Published Application No. 2006/0227538 A1 is a lighting system comprised of 3-10 LED lights located on a vertical strip.

U.S. Pat. No. 7,246,915 issued to Verona, describes an illuminating device for an enclosed receptacle, such as a purse or handbag, attached by tape.

U.S. Pat. No. 7,111,959 issued to Kurcz, describes a duel illumination source with automatic on/off switch.

U.S. Pat. No. 6,508,568 issued to Blue-Recio discloses another light assembly for the interior of a purse. The light assembly consists of a mounting structure to secure the assembly to the inside of a bag. An illumination source which projects light to the interior of the bag, and an on/off switch the user must push to turn the purse light on.

U.S. Pat. No. 6,447,142 issued to Weir describes a purse with a built in fight system that includes a purse outer structure, a battery pack and a light assembly positioned to emit light into the purse chamber.

U.S. Pat. No. 6,431,724 issued to Tedham describes a light for the interior of a purse, having a glow stick mounted to the inside of a purse.

U.S. Pat. No. 5,444,605 by Rivera has a removable type lighting device which attaches to a purse.

U.S. Pat. No. 4,742,438 issued to King describes a light for the interior of a purse, having a light bulb and an electric power supply mounted within a translucent housing temporarily mounted on a bracket permanently attached to the inside of a purse.

There are other light mechanisms that are all cumbersome and large for mounting within the purse. See, for example, U.S. Pat. Nos. 7,207,689; 5,934,790, 5,908,232, 6,120,162, 6,502,951, 7,207,689. U.S. Application No. 2005/0092409, U.S. Application No. 2005/0047120 and U.S. Application No. 2005/0007765.

There are 40+ patents regarding attempts to illuminate purses, handbags and containers. The most applicable are referenced. Others are referenced in such patents as U.S. Pat. Nos. 7,207,689 and 7,246,915 which state many other past references.

Lastly, there is U.S. Application No. 2012/0212940.

### BRIEF SUMMARY OF THE INVENTION

The invention is the application of a lighting source, especially a lighted bag liner added to an existing purse/bag OR built within the interior (bottom and/or sides) of a new purse. When illuminated (i.e., turned on by a switch or phone app), it will help its user see the contents of their purse/bag. This invention further includes a method for installing the wired light liner and an on/off switch (manual, magnetic or remote-phone app) into the bottom and/or side of a new or existing purse, clutch, tote, handbag, shoulder bag, makeup, or shoulder bag.

### BRIEF DESCRIPTION OF THE SEVERAL VIEWS OF DRAWING(S)/PHOTOGRAPHS

Further features, advantages and objectives of this invention will be clearer from the following detailed description made with reference to the accompanying drawings and photograph in which:

FIG. 1 is a top view of an opened purse P, in this case with a zippered closure Z, and handles H, said purse P having a purse interior I prior to the installation of the lighting insert therein;

FIG. 2 is a top perspective view of purse P, from a first side view showing the liner insert L, adequately powered from charger unit C, installed and turned on (by any means, switch, phone app, etc.). Charger unit C can consist of several replaceable, throwaway batteries or a stand alone rechargeable system such as from a phone or laptop charger;

FIG. 3 is a top perspective view of the same purse P, lighted liner L on, with its multiple twinkle bulbs T interconnected and spaced apart in the netting material comprising liner L, said twinkle bulbs being available in a solid white version, dimmer ivory color, multi-colored, or adjustable between a range of individual colored coordinates (such as all red, green, yellow, purple, blue)—with the understanding that said twinkle bulbs T could be: turned on manually (by physical switch and/or phone app); by motion sensor (i.e., when the purse is first opened and used to assist with contents location); or left on for an adjustable preset length of time. Said twinkels are not especially bright—more for mood setting. And they are chosen for their low power consumption These twinkles T should remain, at all times, cool to the touch—even when left on for prolonged stretches of time. In one more preferred version, the twinkles T are part of a coordinated network of purse lights that could be meant to generate a flow of interior light movement(s) such as from left to right, side to side and/or top to bottom;

FIG. 4 is a partial cross-sectional view of the invention shown with a representative exterior layer E for purse P, its adjacent interior I, the netting of lights layer L (with several twinkels T shown), and the optional innermost protective skin layer S, transparent and preferably made from plastic or other polymer so as to prevent accidental damage to the lights layer L and/or tampering with its charger unit C; and

FIG. 5 is a top view of a lighted prototype purse interior, in a darkened environment, to better show the wave of internal lighting provided by this invention.

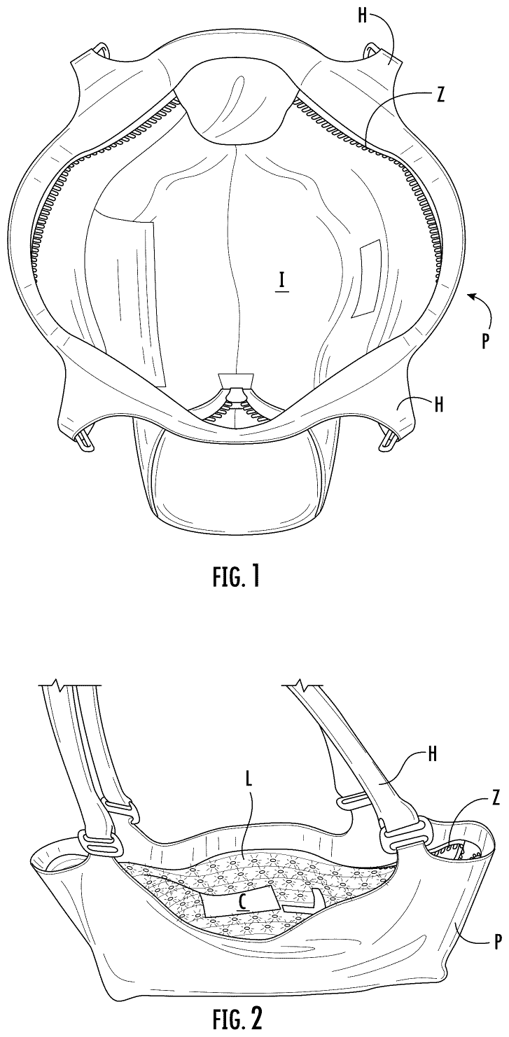

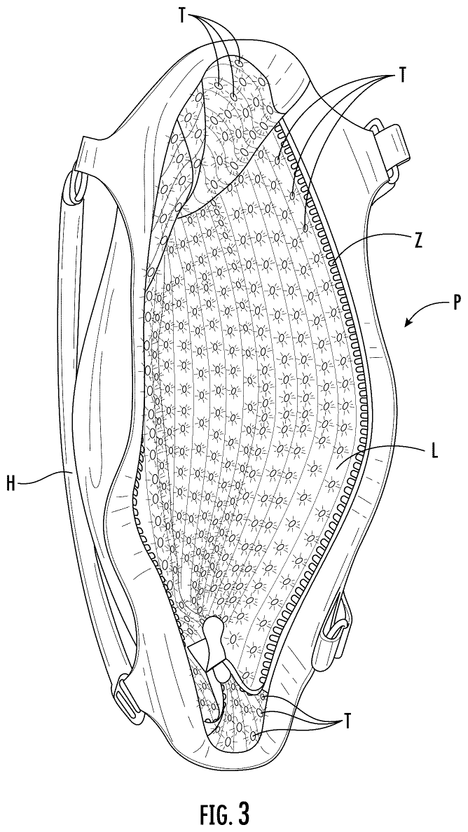

### DETAILED DESCRIPTION OF THE INVENTION

In the accompanying views, common elements between views are commonly lettered. It should be understood, however, that zippered purse P is merely representative of the types of purses, clutches, etc. that can be improved with the present invention. It should also be noted that lighted liners L like those described herein may be made and sold as aftermarket additions (typically size dependent) for consumer purchase and installation into one's existing purse product, or such liners can be made for integral installation—as in built-in to a newly made purse product, from the start.

The invention is the application of a lighting source, especially a lighted bag liner added to an existing purse/bag OR built within the interior (bottom and/or sides) of a new purse. When illuminated (i.e., turned on by a switch or phone app, it will help its user see the contents of their purse/bag. This invention further includes a method for installing the wired light liner and an on/off switch (manual, magnetic or remote-phone app) into the bottom and/or side of a new or existing purse, clutch, tote, handbag, shoulder bag, makeup, or shoulder bag.

In at least one embodiment, the lighting material is a flexible, readily deformable, rather elastic combination of one or more sheets embedded with mini light strings arranged laterally, in parallel, in series or in a weave.

In at least one embodiment, the lighting wires extend to an on/off switch at or near the bottom of purse/bag's opening. In another embodiment, these wires run through the purse lining exiting at an inconspicuous port for periodic charging/recharging.

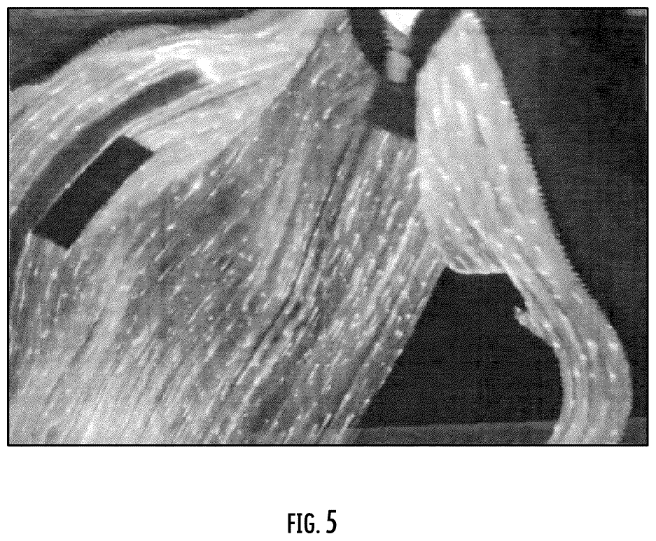

These and other features of this invention are described in, or are apparent from, the following detailed description of various embodiments as shown in the accompanying photographs. Main elements include:
A. An on/off switch—contact, magnetic or remotely activated. Said switch also allows the user to select between light modes including brightness, color and/or sequencing when multiply lit liners are used.
B. A power unit—either an encased battery or a periodically rechargeable variety with appropriate wiring to and from the purse lining proper.
C. A luminous liner to serve as the main purse lighting element. This liner has characteristics suitable for this end use application, including sufficient sheet flexibility, a cool to the touch temperature (when turned on), adjustability in intensity ranging from relatively soft to fairly high brightness, and thin when embedded as multiple bulbs in a sheet form that can be molded in most any shape to a purse/bag interior. It consumes little power, is both vibration and moisture resistant and emits no radiation per se. One representative model of liner material, made by JIANGXI DAISHING POF CO., LTD., was measured and assembled into a lighting unit installed into the prototype shown turned on (and in the dark) fro FIG. 5.

The liner proper is made of three main components:
1. An inverter battery, such as a disposable power cell (one or more AAA's or AA's or periodically rechargeable unit.
2. A programmable inverter that can control the sequences of flashing, colors and/or brightness, customizable by user preference. And
3. One or more netting layers fitted to most if not all purse interior shells. It has conductive electroluminescent materials and circuits inside.

And D. A battery source with low power consumption.

Various exemplary embodiments of this invention will include, in detail:
1. a battery power pack
2. electrical wiring from the battery pack to its light source
3. a netting-like light source for installing into a new or existing purse shell.
4. an optional protective outer liner/plastic layer; and
5. an on/off switch which can be programmed.

The FIGS. show a typical application with a light source along all sides and across the bottom of the purse proper. The on/off switch is connected with wires in the lining to a battery power pack consisting of at least one disposable power cell or rechargeable cell. A protective clear plastic layer protects the light panel from damage.

It should be appreciated that the length of wiring, battery type and on/off switch type are not limited to the construction discussed above. For example, in other embodiments of the invention, the type of bag may be smaller or larger than those pictured. They may also be a different fashion style. As another variation, the lighting may only extend along one side, both sides and/or across a major portion of the purse bottom, depending on bag design.

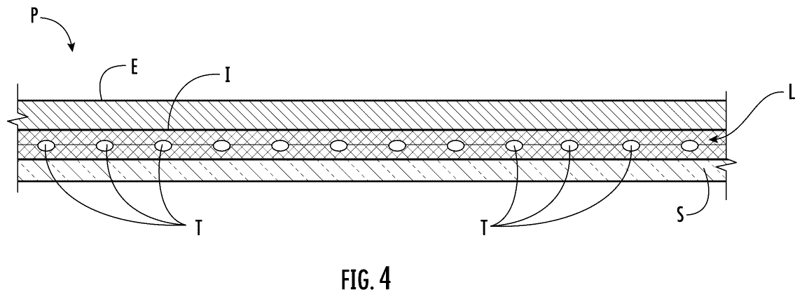

To better protect the lighted lining layer, one optional variation includes a transparent plastic (or other polymer) pocket-such as the innermost skin layer S depicted cross-sectionally in accompanying FIG. 4.

Having disclosed the invention in detail by way of various examples and preferred embodiments, it will be appreciated that variations and modifications of the preferred embodiment may be made without departing from the scope of the invention. It is accordingly intended that the invention not be limited by the above description or accompanying drawings, but that it be defined solely in accordance with the appended claims.

Having described the best modes currently known for practicing this system and method, it is to be understood that the scope of this invention may be further described by the attached claims.

### SEQUENCE LISTING

Not applicable.

1. A purse having an interior light source comprising:
an on-off switch comprising a manual switch or via a phone app,
a battery power pack internal to the purse consisting of either one or more disposable cells or a single repeatedly rechargeable cell; and
an electroluminescent light panel located on the first surface of the purse interior, wherein the on-off switch, the battery power pack, and the light source are each electrically coupled together with one or more wires each independently located in the purse interior.

2. The purse of claim 1 wherein the purse comprises a clutch, a tote, a handbag, a shoulder bag, or a makeup bag.

3. The purse of claim 1, which is newly constructed with one or more electroluminescent light panels.

4. The purse of claim 1, which is retrofit with one or more electroluminescent light panels.

5. The purse of claim 1 wherein the electroluminescent light panel is located along a bottom of the purse interior, one or both sides of the purse interior liner, or a combination thereof.

6. The purse of claim 1 wherein the electroluminescent light panel comprises an inverter battery, an inverter, and one or more programmable electroluminescent materials.

7. The purse of claim 1 wherein the electroluminescent light panel is flexible.

8. The purse of claim 1 wherein the electroluminescent light panel further includes a transparent fabric plastic covering.

9. The purse of claim 1 wherein the light panels consist of a plurality of soft white lights.

10. The purse of claim 1 wherein the light panels consist of a plurality of multi-colored lights.

11. The purse of claim 10 wherein the light panels each cycle through a plurality of multi-colored lights, one color at a time.

12. The purse of claim 1 wherein the light panels illuminate in a wave pattern from left to right, top to bottom, side to side or combinations thereof.

13. The purse of claim 1 wherein the light panels are set to turn on via a motion sensor.

14. The purse of claim 1 wherein the light panels are set to turn off after a preset duration.

15. A lighted netting insert for a new or existing purse comprising:
an on-off switch comprising a manual switch or via a phone app,
a battery power pack internal to the purse consisting of either one or more disposable cells or a single repeatedly rechargeable cell; and
one or more interconnected electroluminescent light panels for locating on a first surface of the purse interior, wherein the on-off switch, the battery power pack, and the light source are each electrically coupled together with one or more wires each independently located in the purse interior.

16. The lighted netting insert of claim 15, which is adapted for locating along a bottom of the purse interior, one or both sides of the purse interior liner, or a combination thereof.

17. The lighted netting insert of claim 1, which is adapted to be situated beneath a transparent fabric plastic covering.

18. The lighted netting insert of claim 15 wherein netting insert consists of a plurality of soft white lights.

19. The lighted netting insert of claim 15 wherein netting insert consists of a plurality of a single color of lights, or multi-colored lights.

20. The lighted netting insert of claim 15 illuminate in a wave pattern from left to right, top to bottom, side to side or combinations thereof.
